(19) United States
(12) Patent Application Publication
(10) Pub. No.: US 2013/0161135 A1
(43) Pub. Date: Jun. 27, 2013

(54) Apparatus for brake of walking support machine

(71) Applicant: Seong-Yoon Kim, Daegu (KR)

(72) Inventor: Seong-Yoon Kim, Daegu (KR)

(21) Appl. No.: 13/374,368

(22) Filed: Dec. 23, 2011

(51) Int. Cl. A61H 3/04; B60T 1/04

(52) U.S. Cl. 188/74

(57) ABSTRACT

The apparatus for the brake of the walking support machine is characterized in that a connective tube 41 is formed at an upper part of a bracket 40 for rotatably supporting the wheels 30, a lower part of the body 10 is vertically and movably inserted into the connective tube 41, a brake pin 50 which is in contact with the wheels 30 in a descending state is installed at the lower part of the body 10 to receive elastic power of a spring 60, a pin hole 42 through which the brake pin 50 passes is formed at a center portion of a lower part of the connective tube 41, and a snap ring 70 is inserted into and is fixed to the brake pin 50 projected through the pin hole 42 to the lower part.

### TECHNICAL FIELD

The present invention relates to an apparatus for a brake of a walking support machine as an aid which disabled patients or elderly people and the like use when walking, and more particularly to an apparatus for a brake of a walking support machine which can prevent a negligent accident due to acceleration on a downhill road and can safely protect a user on an uphill road.

### BACKGROUND ART

In general, a walking support machine has been well known as an aid which patients or weak and elderly people and disabled persons and the like use when walking. The walking support machine is used for supporting and moving a body when walking with a light step or moving to other places.

The prior walking support machine has various shapes but generally includes a body having a frame which is formed by bending a pipe; a grip part which is formed at both sides of an upper part of the body and is caught, pushed or pulled by hands to be moved; and front and rear wheels which are formed at front and rear parts of a lower end of the body.

However, the prior walking support machine lacks a brake function. The disabled patients or the weak and elderly person do not discover any structural problem from the prior walking support machine on a flat road. However, as the disabled patients or the weak and elderly person use the prior walking support machine without a brake when walking on the downhill road, the disabled patients or the weak and elderly person are involved in the negligent accident by a sudden state or an increase of speed due to the weight applied to the walking support machine.

In addition, as described above, as the prior walking support machine lacks the brake function, the prior walking support machine causes the negligent accident and cannot protect the safety of the user by permitting the walking support machine to move downwardly along an inclined road when the disabled patients or the weak and elderly person walk on the uphill road having a predetermined slope.

### DISCLOSURE

### Technical Problem

One object of the prevent invention is to provide an apparatus for a brake of a walking support machine which can prevent a negligent accident due to acceleration on a downhill road and can safely protect a user on an uphill road by using a brake function when walking, so as to solve the prior defects problem.

### Solution to Problem

To accomplish the object, the present invention includes: a body formed with a frame, a grip part formed at both sides of an upper part of the body; and wheels formed at front and rear parts of a lower end of the body. A connective tube is formed at an upper part of a bracket for rotatably supporting the wheels. A lower part of the body is movably inserted into an inside diameter of the connective tube. A brake pin is installed at the lower part of the body so as to be in contact with the wheels in a descending state thereof. The brake pin is moved in the lower part and is in contact with the wheels to perform a braking operation by catching the grip part and pushing the body to a lower part.

### Advantageous Effects of Invention

According to an apparatus for a brake of a walking support machine of the present invention, when the user catches a grip part of the walking support machine and pushes the body to the lower part in the walking state, the brake pin is in contact with the wheels to perform the braking operation. Thus, the present invention can structurally prevent the negligent accident due to the acceleration on the downhill road and can safely protect the user on the uphill road by preventing the backward movement on the uphill road.

### BRIEF DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating an installation state of the present invention;

FIGS. 2a to 3b illustrate a brake system of the present invention;

FIGS. 2a and 2b are sectional views showing operational states of an “A” part in FIG. 1;

FIGS. 3a and 3b are sectional views showing operational states of a “B” part in FIG. 1; and

FIG. 4 is a sectional view showing another embodiment of the present invention.

### DESCRIPTION OF EMBODIMENTS

Reference will now be made in detail to the preferred embodiments of the present invention, examples of which are illustrated in the accompanying drawings.

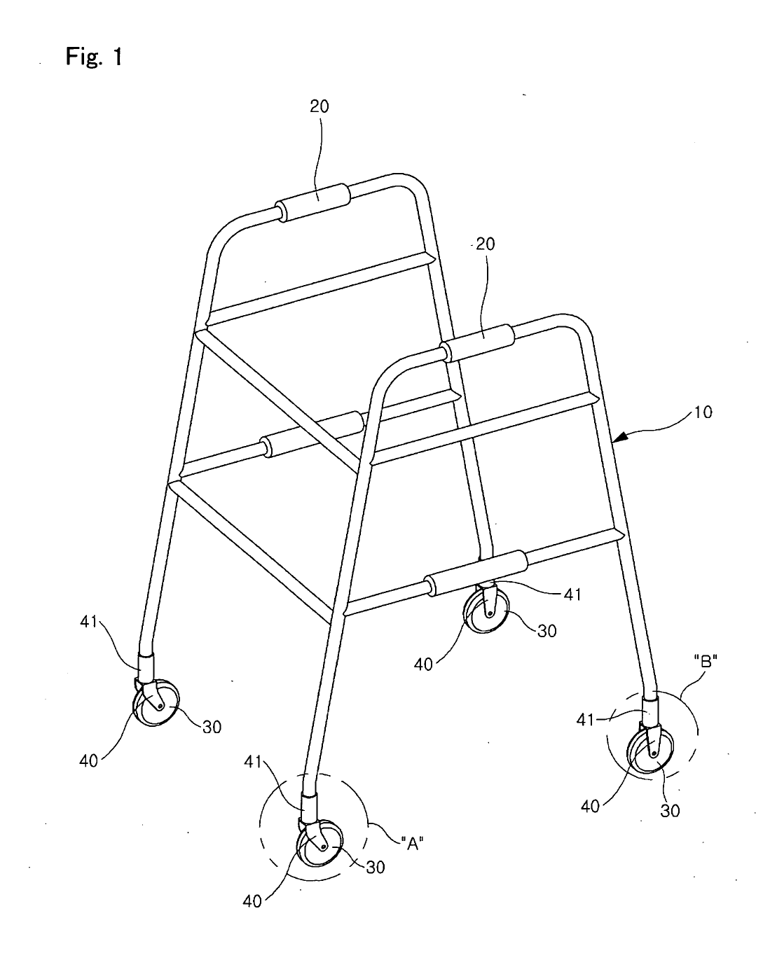

As illustrated in FIGS. 1-3b, an apparatus for a brake of a walking support machine according to the present invention including: a body 10 formed with a frame; a grip part 20 formed at both sides of an upper part of the body 10; and front and rear wheels 30 formed at front and rear parts of a lower end of the body 10, is characterized in that a connective tube 41 is formed at an upper part of a bracket 40 for rotatably supporting the wheels 30, a lower part of front and rear sides of both sides of the body 10 is vertically and movably inserted into the connective tube 41, a brake pin 50 which is in contact with the wheels 30 in a descending state is installed at the lower part of the front and rear sides of both sides of the body 10 to receive elastic power of a spring 60, a pin hole 42 through which the brake pin passes is formed at a center portion of a lower part of the connective tube 41, and a snap ring 70 is inserted into and is fixed to the brake pin 50 projected through the pin hole 42 to the lower part.

Here, the body 10 is used as a main frame corresponding to a basic frame of the walking support machine. The body 10, as shown in FIG. 1, is formed with bent both frames having a structure which are connected by a connective bar.

The grip part 20 is installed at both sides of an upper part of the body 10. The grip part 20 plays a role of catching, pushing, and pulling the walking support machine with hands to operate the walking support machine. That is, a user catches the grip part 20 with the hands and walks in pushing and pulling the walking support machine.

The front and rear wheels 30 are installed at the front and rear sides of the lower end of the body 10. The front and rear wheels 30 play a role of smoothly moving the walking support machine when the user walks.

The bracket 40 supports rotatably the front and rear wheels 30. The connective tube 41 is formed at an upper part of the bracket 40. The lower part of the front and rear sides of the both sides of the body 10 is vertically and movably inserted into the inside diameter of the connective tube 41. At this time, the pin hole 42 through which the brake pin 50 passes is formed at the center of the lower part of the connective tube 41.

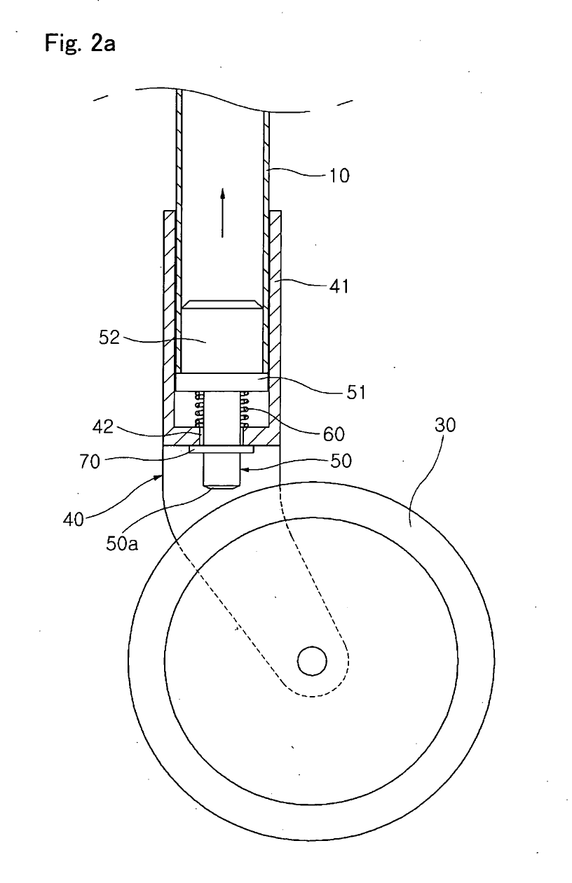

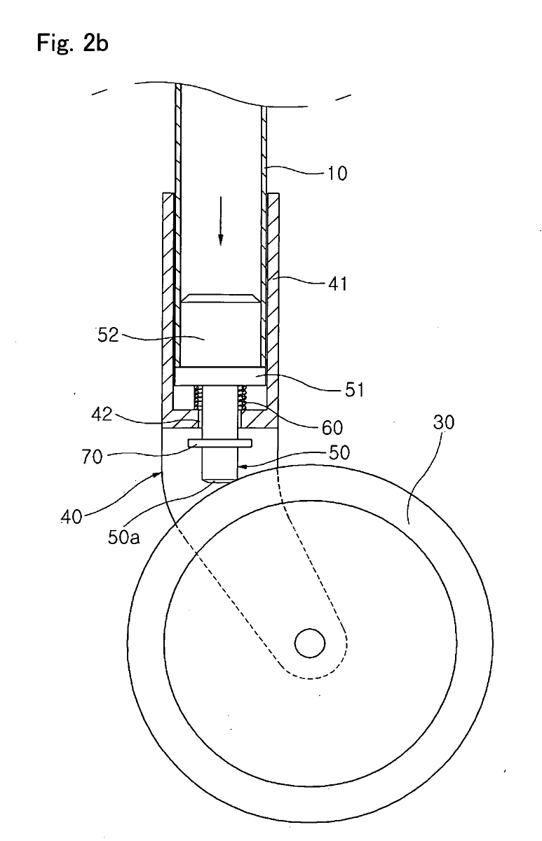

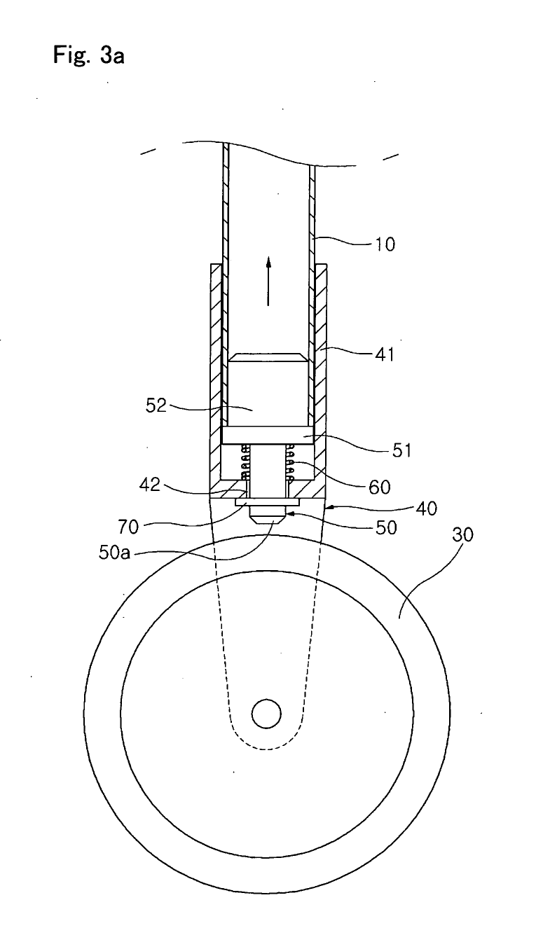

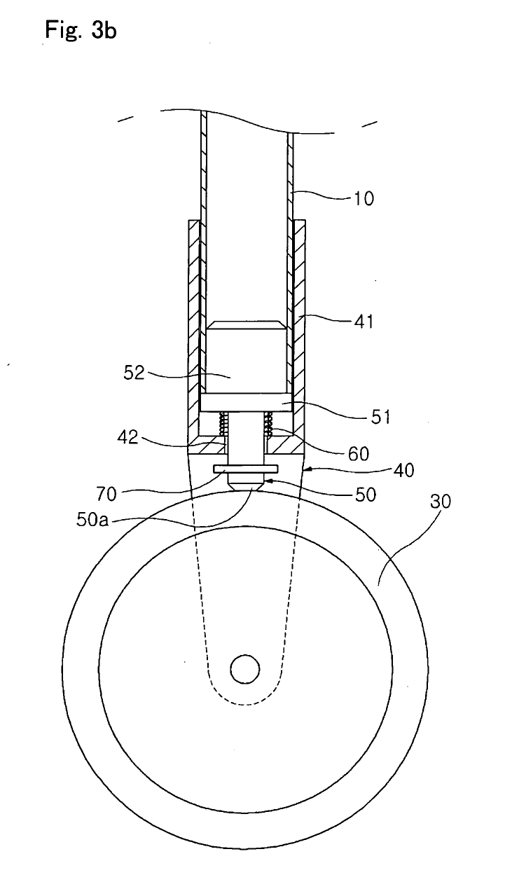

The brake pin 50 is installed at the lower part of the front and rear sides of both sides of the body 10 to receive the elastic power of the spring 60. The brake pin 50, as shown in FIGS. 2a and 3a, is maintained in the elastically rising state by the spring 60 in a normal state. When the body 10 is pushed in the lower part, the brake pin simultaneously descends and is in contact with the wheels 30 to perform the braking operation, as shown in FIGS. 2b and 3b.

A supporting projection 51 which is in contact with a lower end of the body 10 is formed at an upper part of the brake pin 50. A fixing bar 52 which is inserted into the inside of the body 10 by the pressure is formed at an upper part of the supporting projection 51. At this time, the supporting projection 51 plays a role of preventing the insertion of the brake pin 50 into the body 10. The fixing bar 52 plays a role fixing the brake pin 50 to the body 10.

Meanwhile, as shown in FIGS. 3a and 3b, when the brake pin 30 installed at the rear wheel 30 performs the braking operation at an upper part of the center of the wheel 30, a bottom surface of the brake pin 50 is in contact with the wheel 30 in the face to face manner. As shown in FIGS. 2a and 2b, when the brake pin 30 installed at the front wheel 30 performs eccentrically the braking operation at one side instead of the upper part of the center of the wheel, an edge instead of the bottom surface of the brake pin 50 is not in contact with the wheel 30 and causes the lowering effect of the frictional force. A taper 50a is formed on a lower part of the brake pin 50 so as to increase the frictional force of the brake pin 50.

The spring 60 applies the elastic force to the brake pin 50. The spring 60 is inserted into the brake pin 50 and is arranged between the supporting projection 51 and the pin hole 42. Accordingly, as shown in FIGS. 2a and 3a, the brake pin 50 is maintained in the elastically rising state by the elastic force of the spring 60 in the normal state. When the body 10 is pushed in the lower part, the brake pin presses the spring 60 and elastically descends, as shown in FIGS. 2b and 3b.

The snap ring 70 is inserted through pin hole 42 into the brake pin 50 projected to the lower part. The snap ring 70 plays a role of preventing the ejection of the body 10 from the connective tube 41.

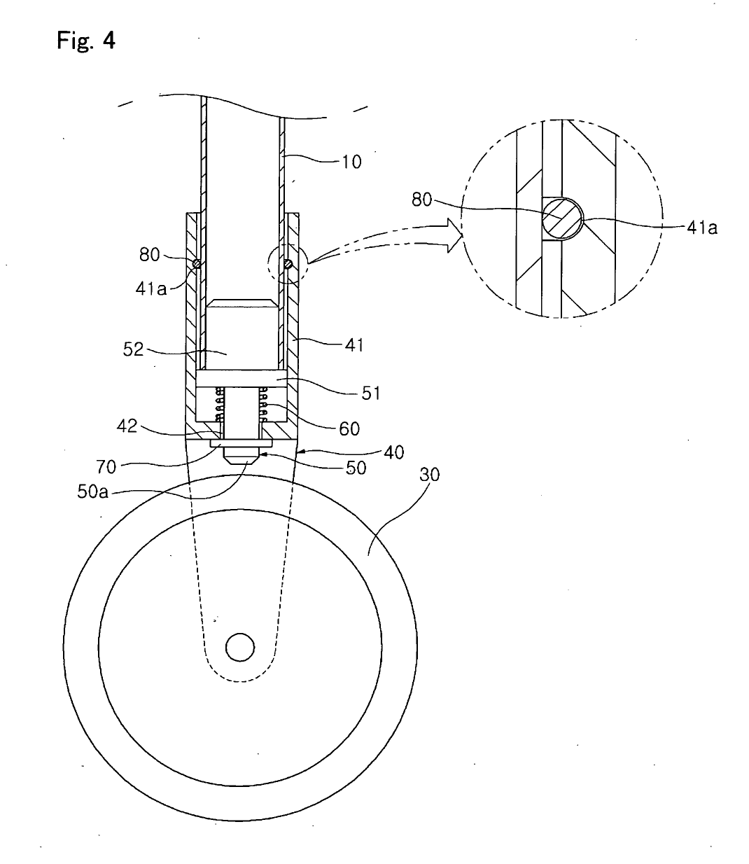

According to another embodiment of the present invention, as shown in FIG. 4, a ball groove 41a is formed at an inside diameter of the connective tube 41. A plurality of balls 80 which are in contact with the body 10 are inserted into the ball groove 41a. According to another embodiment of the present invention, since the balls 80 are arranged between the inside diameter of the connective tube 41 and the outside diameter of the body 10, an elevating operation of the body 10 is smoothly performed.

As described above, the walking support machine of the present invention is used as an aid like before when the patients or the weak and elderly people and the disabled persons walk.

However, the present invention, as shown in FIGS. 2a and 3a, an interval between the brake pin 50 and the wheel 30 is maintained in the normal state to suppress a braking operation by the elastic force of the spring 60. As shown in FIGS. 2b and 3b, when the body 10 is pressed in the lower part, the brake pin 50 is in contact with the wheel 30 to perform the braking operation.

According to the apparatus for the brake of the walking support machine according to the present invention, when the user catches the grip part 20 of both sides with the hands and does not push the grip part 20 to the lower part, the braking power is not transmitted to the wheel 30, as shown in FIGS. 2a and 3a. As shown in FIGS. 2b and 3b, when the user pushes the grip part 20 to the lower part to enable the body 10 to descent to the lower part, the brake pin 50 descends and is in contact with the wheel 30 to perform the braking operation. If the user pushes the grip part 20 when walking, the user prevents the acceleration of the walking support machine and slowly moves and can thereby prevent the negligent accident due to the acceleration.

In addition, according to the apparatus for the brake of the walking support machine according to the present invention, as described above, as the user pushes the grip part 20 to the lower part to perform the braking operation, the backward movement is prevented and the slow movement is possible on the uphill road and the user can be safely protected thereby.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

[Reference Sings List]

| | |
|---|---|
| 10: body | 20: grip part |
| 30: wheel | 40: bracket |
| 41: connective tube | 41a: ball groove |
| 42: pin hole | 50: brake pin |
| 50a: taper | 51: supporting projection |
| 52: fixing bar | 60: spring |
| 70: snap ring | 80: ball |

1. An apparatus for a brake of a walking support machine including: a body 10 formed with a frame; a grip part 20 formed at both sides of an upper part of the body 10; and front and rear wheels 30 formed at front and rear parts of a lower end of the body 10, is characterized in that a connective tube 41 is formed at an upper part of a bracket 40 for rotatably supporting the wheels 30, a lower part of the body 10 is vertically and movably inserted into the connective tube 41, a brake pin 50 which is in contact with the wheels 30 in a descending state is installed at the lower part of the body 10 to receive elastic power of a spring 60, a pin hole 42 through which the brake pin 50 passes is formed at a center portion of a lower part of the connective tube 41, and a snap ring 70 is inserted into and is fixed to the brake pin 50 projected through the pin hole 42 to the lower part.

2. The apparatus for the brake of the walking support machine of claim 1, wherein a supporting projection 51 which is in contact with a lower end of the body 10 is formed at an upper part of the brake pin 50 and a fixing bar 52 which is inserted into the inside of the body 10 by the pressure is formed at an upper part of the supporting projection 51.

3. The apparatus for the brake of the walking support machine of claim 1, wherein a taper 50a is formed on a lower part of the brake pin 50.

4. The apparatus for the brake of the walking support machine of claim 1, wherein a ball groove 41a is formed at an inside diameter of the connective tube 41 and a plurality of balls 80 which are in contact with the body 10 are inserted into the ball groove 41a.
